(19) United States
(12) Patent Application Publication
(10) Pub. No.: US 2010/0032252 A1
(43) Pub. Date: Feb. 11, 2010

(54) BRAKE DISK, PARTICULARLY FOR MAGNETIC BRAKING

(75) Inventors: Wilhelm Rosa, Obersontheim-Mittelfischach (DE); Ulrich Hense, Landsberg/Lech (DE)

Correspondence Address: Muncy, Geissler, Olds & Lowe, PLLC, P.O. BOX 1364, FAIRFAX, VA, 22038-1364, US

(73) Assignee: REX INDUSTRIE-PRODUKTE GRAF VON REX GMBH, Vellberg (DE)

(21) Appl. No.: 12/532,039

(22) PCT Filed: Mar. 19, 2008
(86) PCT No.: PCT/EP08/02210

§ 371 Date: Sep. 29, 2009

(30) Foreign Application Priority Data
Mar. 20, 2007 (DE) 10 2007 013 401.2

(51) Int. Cl. F16D 65/12

(52) U.S. Cl. 188/218 XL

(57) ABSTRACT

The present invention relates to a brake disk (9), in particular a brake disk (9) for an electromagnetic brake, which can be used as an emergency stop brake and/or as a dynamic brake. In order to ensure that when the weight is low, the actuation force between the friction partners is large because of a magnetic field which is switched on, the brake disk (9) has a support (10) made of friction material and a metal ring (11, 11′) which is disposed concentrically thereon.

The present invention relates to a brake disk and, in particular, a brake disk which is suitable for magnetic brakes and which is to be used in vehicles, for example as an emergency stop brake or a dynamic brake.

Brake disks of conventional vehicle disk brakes usually consist of metal and are suitably connected fixedly in terms of rotation to the respective wheel to be braked. For braking, a brake disk of this type is then clamped to a greater or lesser extent, depending on the desired braking action, between two friction linings which are attached in a stationary manner to the vehicle.

DE 60 2005 000 056 T2 discloses a brake disk for rail vehicles which has a hub provided with a carrier plate. Two brake friction plates are arranged in the form of a ring on the carrier plate and constitute the actual contact friction surfaces. The brake friction plates are connected to the carrier plate by means of suitable connection elements, such as, for example screw bolts.

DE 103 58 320 A1 already discloses friction bodies which have, in general, a carrier or a carrier plate and at least one friction lining arranged on it. In this case, both the carrier and the at least one friction lining arranged on it consist of hardened friction materials based on reinforcing fibers, heat-hardenable binders and conventional fillers, so that the friction body is produced in one piece. Friction bodies of this type can be used as brake, clutch or other friction linings.

DE 197 52 543 A1 discloses a magnetic brake of bistable design, in which an armature disk arranged fixedly in terms of rotation in the magnetic brake housing is provided with a brake lining in the form of an annular disk which is fixedly attached to it. A brake disk or clutch disk is pressed fixedly in terms of rotation on a drive shaft which is to be braked or to be locked. For braking or locking the drive, the armature of the magnetic brake is pressed against the clutch disk, so that the drive is braked and locked as a result of the frictional connection between the annular brake lining arranged fixedly in terms of rotation on the armature disk and the clutch disk.

DE 10 2005 006 699 A1 discloses an electromagnetic brake with a permanent magnet, which brake can be used as an emergency stop brake or dynamic brake for a drive, for example an electric drive for a vehicle wheel. This known magnetic brake has a brake body with a permanent magnet which is held fixedly in terms of rotation on the stator or housing of the drive via a bearing plate. An armature of the magnetic brake is arranged, via a sleeve provided with a flange, fixedly in terms of rotation on a drive shaft to be braked, such that said armature can be displaced axially between a braking position and a release position.

The braking of the drive takes place by means of a frictional connection between the armature and the corresponding end face of the brake body. Particularly when this known magnetic brake is to be used as an emergency stop brake or dynamic brake, it is expedient to provide the brake body with a brake lining in the region of its end face, in order to increase the frictional connection between the brake body and armature. In this case, therefore, the armature together with the sleeve having a flange, forms a brake disk which is arranged fixedly in terms of rotation on the shaft to be braked which is pressed against the brake lining or brake linings on the brake body.

The object on which the invention is based is to provide a brake disk for an electromagnetic brake, which can be used, in particular, as an emergency stop brake and/or dynamic brake, which, along with a low mass, ensures a high actuation force between the friction partners by virtue of a magnetic field which is switched on.

This object is achieved by means of the brake disk as claimed in claim 1. Advantageous refinements and developments of the invention are described in the subclaims.

The brake disk according to the invention therefore has a carrier consisting of friction material, on which a metal ring is arranged concentrically thereto. The invention thus departs from the principle, customary in magnetic brakes, of using a metallic armature or a metallic brake disk and, where appropriate, inserting between the armature and the corresponding friction countersurface friction materials for the purpose of increasing the frictional resistance, and, instead, uses a carrier consisting of friction material with a metal ring which consequently can be reduced to its function as an armature, in order to achieve an optimal ratio between the mass of the brake disk and the magnetic attraction force between the armature and magnetic brake body.

Furthermore, the brake disk according to the invention has a very good damping behavior with respect to vibrations on account of the use of a carrier consisting of friction material, with the result that unnecessary noises can also be avoided.

In an expedient development of the invention, there is provision for the metal ring to be held positively on the carrier, the metal ring being pressed into the carrier. Simply by the metal ring being pressed positively into the carrier consisting of friction material, a very good connection of the two materials to one another can be achieved, so that the brake disk according to the invention attains long service lives even when the required braking forces, including force pulse peaks, are being transmitted.

It is also possible, however, that the metal ring is held on the carrier in a materially integral manner.

In the case of both a positive connection and a materially integral connection, it is possible to improve the fastening of the metal ring on the carrier further by using an adhesion promoter.

If the means for holding the metal ring on the carrier are suitably selected as a function of the field of use of the size of the brake disk, the service life of the brake according to the invention, having a high load alternation resistance, can be improved such that the brake operates over at least 10 million switching cycles without a failure of the brake disk.

In order, in particular, to improve further the positive connection between the metal ring and the carrier consisting of friction material for the purpose of absorbing shear forces occurring in the disk plane, there is provision according to the invention for the metal ring to have on its inner circumference one or more dog extensions directed radially inward, preferably the dog extension or dog extensions having widened tips, as seen in a top view, in order to optimize the force flux.

Although a multiplicity of the most diverse forms are possible for improving the introduction of force, it is preferable that the widened tips of the dog extensions are drop-shaped, circular, elliptic or polygonal, as seen in a top view.

In another embodiment of the invention, there is provision for the metal ring to consist of at least one inner ring and one outer ring which are connected to one another via one or more webs.

Expediently, the metal ring of the brake disk according to the invention which assumes the function of an armature of a magnetic brake is configured according to the position of the magnetic poles of the magnetic brake. In order further to optimize the introduction of force and the transmission of force during load alternation and during braking, in a particularly advantageous embodiment of the invention there is provision for the dog extensions or the webs to be arranged so as to be uniformly distributed circumferentially.

Although it is basically conceivable to use any ferromagnetic metal for the metal ring, it became apparent that a metal ring consisting of magnetizeable sheet steel best fulfils the requirements demanded of the brake disk in a magnetic brake.

In order to optimize the transmission of the braking forces between the stationary brake body of the magnetic brake and a shaft to be braked, there is expediently provision for the carrier in the form of a circular disk, which consists of friction material, to have a central hub portion with a concentric through orifice for receiving a shaft to be braked, and a flange portion concentrically surrounding the hub portion and having at least one friction surface, the hub portion having an axial thickness which is equal to the thickness of the flange portion or which is larger than the thickness of the latter.

In order to achieve an optimal torsional strength between the brake disk and the braking shaft, without impairing an easy axial displaceability of the brake disk for the rapid activation of the brake, it is expedient if the inner circumferential surface of the through orifice in the hub portion is provided with take-up means for rotationally fixed mounting on a shaft to be braked.

It is basically conceivable that the through orifice of the hub portion has any desired nonround shape—triangular, square, flattening with an axial groove or the like—which matches with the outer circumference of the shaft to be braked and is suitable for rotationally fixed mounting. However, there is advantageous provision for the take-up means to be formed by toothing for receiving a shaft toothing on the shaft to be braked. Preferably, therefore, the inner circumferential surface of the through orifice in the hub portion has a toothing for receiving a shaft toothing of the shaft to be braked.

Although it is basically possible to provide the brake disk according to the invention with a smooth, that is to say uninterrupted friction surface, in an advantageous embodiment of the invention there is provision for providing on the flange portion two or more friction surfaces projecting axially beyond the surface of the metal ring in a segment-like manner, the number of segment-like friction surfaces corresponding to the number of the dogs or webs of the metal ring. The division of the friction surface into friction surface elements which preferably correspond to the number of dogs or webs of the metal ring leads to a further reduction in noise.

In order to fulfill the stringent requirements in terms of coefficient of friction, wear, thermal behavior, etc., demanded of the brake disk of a magnetic brake which is to be used as an emergency stop brake and/or dynamic brake in vehicles, in particular in passenger cars, it is necessary for the carrier to be produced from a fiber-filled high-strength friction material.

The invention is described below, by way of example, with reference to exemplary embodiments illustrated in the drawing in which:

FIG. 1a shows a top view of a brake disk according to the invention;

FIG. 1b shows a section through a brake disk according to the invention essentially along the line Ib-Ib in FIG. 1a;

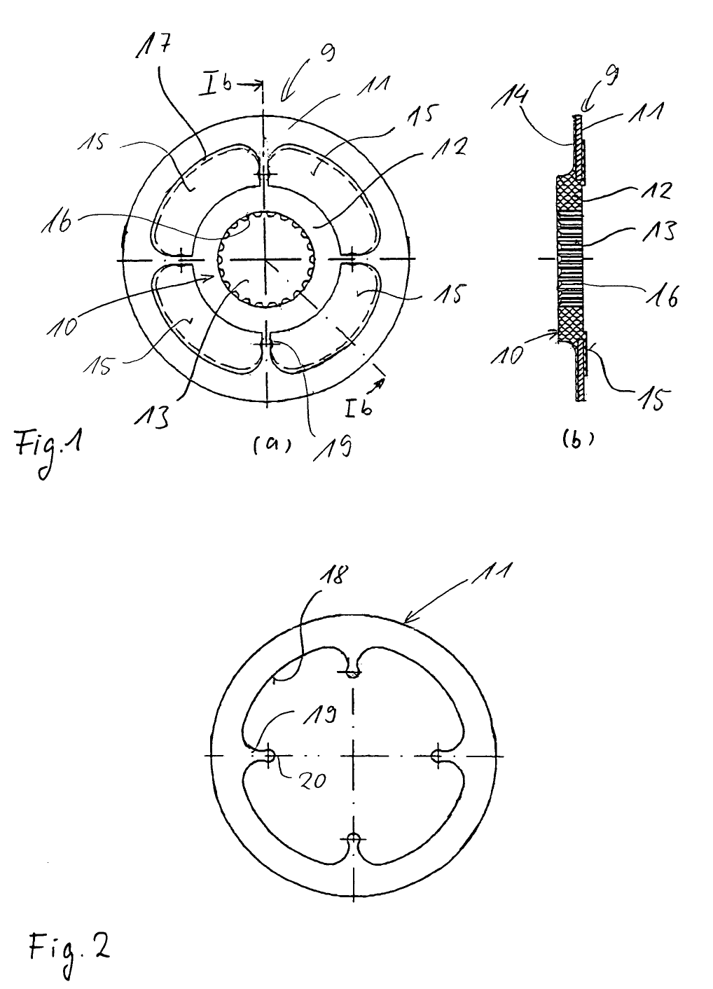

FIG. 2 shows a top view of a metal ring for a brake disk according to the invention;

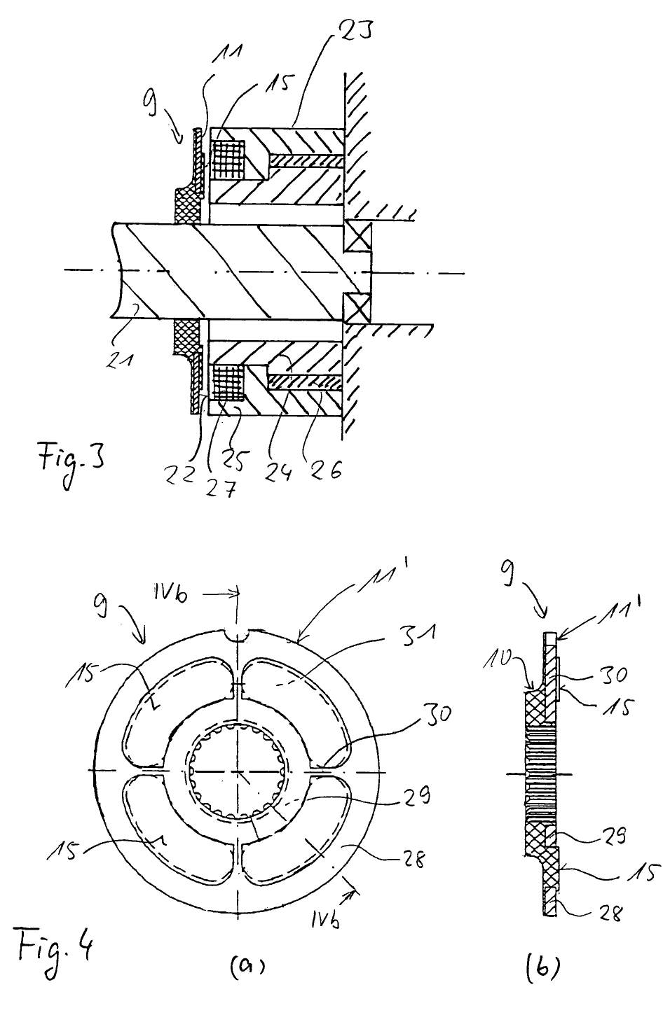

FIG. 3 shows a greatly simplified diagrammatic sectional illustration of a magnetic brake arranged on a drive and having a brake disk according to the invention;

FIG. 4a shows a top view of another embodiment of a brake disk according to the invention; and

FIG. 4b shows a section through a brake disk 9 according to the invention essentially along the line IVb-IVb in FIG. 4a.

In the various figures of the drawing, components corresponding to one another are given the same reference symbols.

As illustrated in FIG. 1, the brake disk 9 according to the invention has a carrier 10 consisting of friction material and a metal ring 11. The carrier 10 is designed in the form of a circular disk and comprises a central hub portion 12 with a through orifice 13 arranged concentrically to the outer circumference of the carrier 10, and an annular flange portion 14 which concentrically surrounds the hub portion 12 and in the region of which at least one friction surface 15 is provided.

In the exemplary embodiment illustrated, the hub portion 12 has in the axial direction of the through orifice 13 a thickness which is about two to three times as large as the thickness of the brake disk 9 in the region of the flange portion 14. In an embodiment illustrated, the thickness of the hub portion lies in the range of about 3 to 10 mm, in particular of about 6.5 to 7 mm, while the thickness of the flange portion 14 lies between 1.5 and 4 mm and, in particular, at about 2.5 mm. It is also possible, however, to select the thickness of the hub portion and that of the flange portion so as to be equal, without thereby impairing the functioning capacity of the brake disk 9. In particular, it must be remembered that the thickness dimensions indicated in the exemplary embodiments depend very greatly on the field of use and on the size, that is to say, in particular, on the required diameter of the brake disk. In brake disks with a diameter of 200 mm or 300 mm, such as are planned for heavy load and railroad traffic, then correspondingly larger thicknesses of the brake disk are also required.

In order to arrange the brake disk 9 fixedly in terms of rotation, but axially displaceably, on a shaft to be braked, for example on a drive shaft to be braked, the inner circumferential surface of the through orifice 13 is provided with a toothing 16 which engages into a corresponding toothing on a shaft to be braked.

Instead of the toothing illustrated for the rotationally fixed mounting of the brake disk 9 on the shaft 21, any other known nonround form may also be selected. For example, the shaft may have a shaft stud which is designed as a square, or flattened, and with an axial spring and onto which the brake disk is then placed with a corresponding square orifice or with a flattened orifice having a counter groove.

The carrier 10 is produced from a fiber-filled high-strength friction material, such as is specified, for example, in DE 30 46 696.

The metal ring 11, which is designed as an individual outer ring, is pressed into the carrier 12 when the brake disk is being produced, such that the carrier material at least partially overlaps the metal ring in order to make a positive connection between the metal ring 11 and the carrier 12, as is indicated at 17 in FIG. 1. With the thickness of the flange portion of about 2.5 mm, the metal ring 11 may have a thickness of, for example, approximately 1.25 mm. In particular, the thickness of the metal ring lies in the range of ⅔ to ¼ of the thickness of the brake disk in the region of the metal ring 11, that is to say, here, in the region of the flange portion. These dimensions, too, are dependent on the construction size.

As illustrated in FIG. 2, the metal ring 11 has on its inner circumference 18 a plurality of dog extensions 19 which are directed radially inward and the radially inner tips 20 of which are of drop-shaped design, as seen in a top view. To optimize the force flux, other suitable shapes of the widened tips may also be provided, such as, for example, circles, triangles, squares, lozenges, hearts, ovals or the like. Basically, both the arrangement and the number of the dog extensions 19 may be selected as desired. In this case, with larger brake disk diameters, more dog extensions may be provided than with smaller diameters. In the brake disk illustrated with a diameter of approximately 70 mm, the number of dog extensions expediently lies in the range of 2 to 12, in particular between 2 and 7, and preferably around 4, these then also preferably being distributed uniformly in the circumferential direction, so that the dynamic behavior of the brake disk both during the rotation and during axial displacement is optimized.

As can be seen further in FIG. 1, the carrier 12 has, divided up by the dog extensions 19 of the metal ring 4, friction surfaces 15 which are arranged in a sector-shaped manner and which lie above the surface of the metal ring 11 and overlap this at 17. Although a smooth surface of the friction surface 15, that is to say a non-subdivided friction surface, is basically also possible, a friction surface subdivided into individual friction surface segments according to the dog extensions of the metal ring is preferred, since a subdivision of the friction surface into individual segments is advantageous for a reduction of noise.

As illustrated in FIG. 3, the brake disk 9 according to the invention is mounted fixedly in terms of rotation, but displaceably in the axial direction, on a shaft 21 to be braked, such that the metal ring 11 produced from sheet steel and the friction surfaces 15 lie opposite a corresponding friction countersurface 22 of a rotationally fixedly mounted brake body 23 of a magnetic brake. The brake body 23 consists, for example, of an inner ring 24, of an outer ring 25 and of a permanent magnet 26 arranged between these. A magnet coil 27 mounted between the inner ring 24 and the outer ring 25 in the region of the friction countersurface 22 of the magnetic brake serves for compensating the magnetic field generated by the permanent magnet 26, so that, with the magnet coil 27 switched on, the brake disk 9 can be moved away from the friction countersurface 22 of the magnetic brake by means, not illustrated. However, as soon as the current through the magnet coil 27 is switched off, the brake disk 9 is pulled into its braking position by the magnetic forces acting on the metal disk 11 acting as an armature.

The brake disk 9 illustrated in FIG. 4 has a metal ring 11′ with an outer ring 28 and with an inner ring 29 which are connected to one another via webs 30. The carrier 10 consisting of friction material extends through the apertures 31, delimited by the inner ring 29, outer ring 28 and webs 30, of the metal ring 11′ in order to form friction surfaces 15 and again, at the margins of the apertures 31, forms overlaps 17 which improve the positive holding of the metal ring on the carrier 10.

Instead of or in addition to the positive connection, a materially integral connection may be provided in order to hold the metal ring 11, 11′ on the carrier 10. In order to improve the materially integral connection and increase the adhesion between the metal ring 11, 11′ preferably consisting of sheet steel and the carrier 10, an adhesion promoter may be provided.

The number of webs 30 between the inner and the outer ring 29, 28 in the metal ring 11′ according to FIG. 4, and also the number of dog extensions, can be selected, as desired, between 1 and n, particularly taking into account the diameter of the brake disk or its circumferential length in the region of the webs, and, in the exemplary embodiment illustrated, with a brake disk diameter of about 70 mm the number of webs should lie in the range of 2 to 12, preferably between 2 and 7.

Finally, it should also be pointed out that the metal ring 11, 11′ may be provided not only on its inner circumference, but also on its outer circumference, with dog extensions which either supplement or even replace the inner dog extensions. If the outer dog extensions which extend essentially radially outward are provided in addition to the inner dog extensions, then it is basically conceivable to select the number and arrangement of the outer dog extensions independently of those of the inner dog extensions, but, to optimize the transmission of force between the carrier and metal ring, it is expedient to align the outer dog extensions with the inner dog extensions, in which case each inner dog extension may be assigned one, two or more outer dog extensions.

If only outer dog extensions are provided, these are distributed individually, or combined in groups, uniformly over the outer circumference of the metal ring. The outer dog extensions are therefore arranged in the plane of the brake disk symmetrically with respect to the axis of rotation of the brake disk.

Although, in the illustrated embodiments of the brake disk according to the invention, the inner dog extensions or webs are arranged so as to be individually uniformly distributed circumferentially, it is also possible, in the case of the inner dog extensions, also to provide, for example instead of four individual dog extensions, four groups in each case of two, three or more dog extensions or webs which then lie symmetrically with respect to the axis of rotation of the brake disk in order to avoid an unbalance.

1. Brake disk with:
a carrier consisting of friction material and
a metal ring arranged concentrically thereon.

2. The brake disk as claimed in claim 1, wherein the metal ring is held positively on the carrier.

3. The brake disk as claimed in claim 1, wherein the metal ring is pressed into the carrier.

4. The brake disk as claimed in claim 1, wherein the metal ring is held on the carrier in a materially integral manner.

5. The brake disk as claimed in claim 4, wherein the metal ring is held on the carrier, using an adhesion promoter.

6. The brake disk as claimed in claim 1, wherein the metal ring consisting of an outer ring has on its inner circumference one or more dog extensions directed radially inward.

7. The brake disk as claimed in claim 6, wherein the dog extension or dog extensions has or have widened tips, as seen in a top view, in order to optimize the force flux.

8. The brake disk as claimed in claim 7, wherein the widened tips of the dog extensions are drop-shaped, circular, elliptic or polygonal, as seen in a top view.

9. The brake disk as claimed in claim 1, wherein the metal ring consists of at least one inner ring and one outer ring which are connected to one another via one or more webs.

10. The brake disk as claimed in claim 6, characterized in that the dog extensions or the webs are arranged so as to be uniformly distributed circumferentially.

11. The brake disk as claimed in claim 1, wherein the metal ring consists of magnetizeable sheet steel.

12. The brake disk as claimed in claim 1, wherein the carrier in the form of a circular disk, which consists of friction material, has a central hub portion with a concentric through orifice for receiving a shaft to be braked, and a flange portion concentrically surrounding the hub portion and having at least one friction surface.

13. The brake disk as claimed in claim 12, wherein the hub portion has an axial thickness which is equal to the thickness of the flange portion or which is larger than the thickness of the latter.

14. The brake disk as claimed in claim 12, wherein the inner circumferential surface of the through orifice in the hub portion is provided with take-up means for rotationally fixed mounting on a shaft to be braked.

15. The brake disk as claimed in claim 14, wherein the take-up means are formed by a toothing for receiving a shaft toothing on the shaft to be braked.

16. The brake disk as claimed in claim 12, characterized in that two or more friction surfaces projecting axially beyond the surface of the metal ring in a segment-like manner are provided on the flange portion.

17. The brake disk as claimed in claim 16, wherein the number of segment-like friction surfaces corresponds to the number of dogs or webs of the metal ring.

18. The brake disk as claimed in claim 1, wherein the carrier is produced from a fiber-filled high-strength friction material.

19. The brake disk as claimed in claim 1, wherein the metal ring has on its outer circumference two or more dog extensions which are preferably arranged symmetrically with respect to the axis of rotation of the brake disk.
